(19) United States
(12) Patent Application Publication
(10) Pub. No.: US 2007/0101777 A1
(43) Pub. Date: May 10, 2007

(54) ESCUTCHEON ASSEMBLY

(75) Inventor: Mu-Lin Shen, Tainan (TW)

Correspondence Address: NIKOLAI & MERSEREAU, P.A., 900 SECOND AVENUE SOUTH, SUITE 820, MINNEAPOLIS, MN, 55402, US

(73) Assignee: I-TEK METAL MFG. CO., LTD., Tainan (TW)

(21) Appl. No.: 11/163,954

(22) Filed: Nov. 4, 2005

(51) Int. Cl. E05B 59/00; E05B 63/14

(52) U.S. Cl. 70/107

(57) ABSTRACT

An escutcheon assembly for a lock includes a mounting plate and a cover plate. The mounting plate is mounted to a front face of a door. The mounting plate comprises a receiving section for receiving a lock body of a lock cylinder. The cover plate is securely mounted around the mounting plate. The cover plate comprises a figure-8-shaped through-hole aligned with a figure-8-shaped cross section of an interchangeable lock core removably mounted in the lock body. The mounting plate and the cover plate can be made by inexpensive punching. Replacement of the cover plate, when desired, can be easily achieved at a low cost.

### BACKGROUND OF THE INVENTION

1. Field of the Invention

The present invention relates to an escutcheon assembly. More specifically, the present invention relates to an escutcheon assembly for a lock having an interchangeable lock core of figure-8 cross section.

2. Description of the Related Art

U.S. Pat. No. 4,873,853 discloses an escutcheon assembly for receiving a lock cylinder having an interchangeable lock core of figure-8 cross section. The escutcheon assembly comprises a cover plate and a pair of mounting posts for attaching the cover plate to a door. The cover plate includes a lock cylinder-receiving cavity for holding a lock cylinder. The lock cylinder-receiving cavity includes an annular rear opening and a figure-8-shaped front aperture. An interchangeable lock core is received in a lock body of the lock cylinder. In use, the interchangeable lock core is easily removable from its home in the lock body of the lock cylinder through the figure-8-shaped aperture by using a conventional control key to release the lock core in the normal way. The lock core has a figure-8-shaped cross section matching the shape of the front aperture so that the lock core can be easily pulled out from the lock body without removal or disruption of the mounted cover plate. Thus, the escutcheon assembly presents a sleek, attractive appearance without obstructing removal of the interchangeable lock core from the lock cylinder, for one can only see the figure-8-shaped front face of the lock core via the figure-8-shaped front opening from outside.

However, the cover plate must be thick enough to provide sufficient strength and the lock cylinder-receiving cavity must be wide enough to receive the lock cylinder such that the cover plate must be manufactured by forging or casting. The manufacturing cost is high and manufacturing flexibility is limited. Further, the cover plate is fixed to the door by a pair of screws passing through the mounting posts, which screws are exposed on an inner side of the door, adversely affecting the appearance. Further, when the outer face of the cover plate stains or rusts, the replacement of the cover plate is troublesome and costly.

### SUMMARY OF THE INVENTION

An escutcheon assembly in accordance with the present invention is provided for a lock comprising a lock cylinder that includes a lock body and an interchangeable lock core that is removably mounted in the lock body and that has a figure-8-shaped cross section.

The escutcheon assembly in accordance with the present invention comprises a mounting plate and a cover plate. The mounting plate is adapted to be mounted to a front face of a door. The mounting plate comprises a receiving section for receiving the lock body. The cover plate is securely mounted around the mounting plate. The cover plate comprises a figure-8-shaped through-hole aligned with the figure-8-shaped cross section of the interchangeable lock core.

The mounting plate and the cover plate can be made by inexpensive punching. Replacement of the cover plate, when desired, can be easily achieved at a low cost.

Preferably, the receiving section of the cover plate comprises a recessed portion extending rearward from an inner face of the mounting plate. The receiving section comprises an end wall having a through-hole through which the lock body extends.

Preferably, the cover plate comprises a perimeter wall securely engaged with a perimeter of the mounting plate.

Preferably, the figure-8-shaped through-hole of the cover plate has a size substantially the same as that of the figure-8-shaped cross section of the interchangeable lock core.

Preferably, the mounting plate comprises two mounting posts each having a screw hole, and two screws extend into the screw holes of the mounting posts for fixing the mounting plate to the door.

Preferably, the cover plate further comprises an opening through which an end of an outside handle extends.

Other objectives, advantages, and novel features of the invention will become more apparent from the following detailed description when taken in conjunction with the accompanying drawings.

### BRIEF DESCRIPTION OF THE DRAWINGS

FIG. 1 is a front elevational view of an escutcheon assembly in accordance with the present invention mounted on a door.

FIG. 2 is a sectional view taken along plane 2-2 in FIG. 1.

FIG. 3 is an exploded perspective view of the escutcheon assembly in accordance with the present invention.

FIG. 4 is an enlarged view of a portion of the escutcheon assembly in FIG. 2.

### DETAILED DESCRIPTION OF THE PREFERRED EMBODIMENT

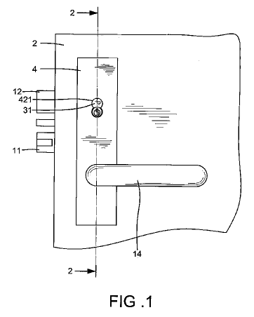

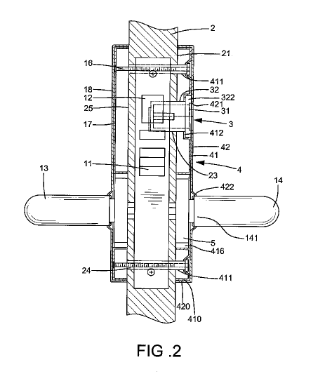

Referring to FIGS. 1 through 4, an escutcheon assembly 4 in accordance with the present invention comprises a mounting plate 41 and a cover plate 42. The mounting plate 41 is mounted to an outer face of a door 2 and the cover plate 42 is mounted around the mounting plate 41 and covers the mounting plate 41.

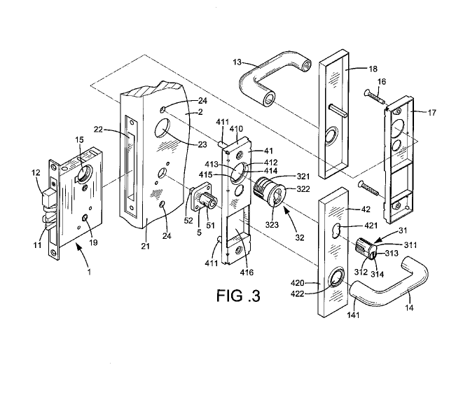

Referring to FIG. 3, the door 2 includes a compartment 22 in an edge thereof for receiving a lock case 1. In this example, the lock case 1 includes a latch bolt 11 operable by turning an inside handle 13 or an outside handle 14. The lock case 1 further includes a deadbolt 12 operable by turning a lock core 31 of a lock cylinder 3.

The lock core 31 is an interchangeable lock core having a figure-8-shaped cross section. The lock core 31 comprises an upper lobe 311 and a lower lobe 312. A key plug 313 is mounted in the lower lobe 312 and includes a keyway 314. The lock core 31 is mounted in a hollow lock body 32 of the lock cylinder 3. The lock body 32 includes a threaded rear end 321 for threadedly engaging with a screw hole 15 in the lock case 1 after passing through a hole 23 in the door 2.

The mounting plate 41 comprises two mounting posts 411 respectively extending through mounting holes 24 in the door 2, with two screws 16 respectively extending through a fixing plate 17 mounted to an inner face of the door 2 into screw holes (not labeled) in the respective mounting posts 411, thereby fixing the mounting plate 41 and the fixing plate 17 in place, as shown in FIG. 3.

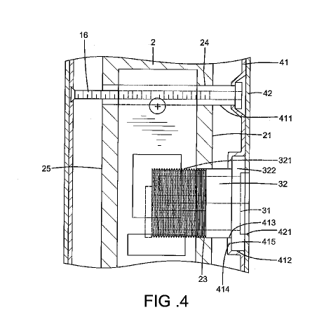

Referring to FIG. 4, the mounting plate 41 comprises a receiving section 412 for receiving the lock body 32. In this example, the receiving section 412 is a substantially hollow section extending rearward from an inner face of the mounting plate 41 to form a recessed portion 414. The receiving section 412 includes an end wall 415 with a through-hole 413 through which the lock body 32 extends. Preferably, a flange 322 on a front end of the lock body 32 is received in the recessed portion 414 such that the front face of the lock body 32 is flush with the front face of the mounting plate 41. The rear threaded end 321 of the lock body 32 is threadedly engaged with the screw hole 15 of the lock case 1.

The cover plate 42 has a perimeter similar to that of the mounting plate 41 and is tightly mounted around the mounting plate 41 by a perimeter wall 420. The cover plate 42 comprises a figure-8-shaped through-hole 421 aligned with the receiving section 412. Preferably, the size of the figure-8-shaped through-hole 421 of the cover plate 42 is substantially the same as that of a figure-8-shaped hole 323 of the lock body 32 that receives the lock core 31. Namely, the size of the figure-8-shaped through-hole 421 of the cover plate 42 is substantially the same as that of the figure-8-shaped cross section of the lock core 31. When the lock cylinder 3 is mounted in the receiving section 412 and the cover plate 42 is mounted outside the mounting plate 41, the figure-8-shaped through-hole 421 of the cover plate 42 is aligned with the figure-8-shaped cross section of the lock core 31, as shown in FIGS. 1 and 3.

The cover plate 42 may further include an opening 420 through which an end 141 of the outside handle 14 extends. The end 141 of the outside handle 14 is coupled with a shaft 51 of a spring device 5 having a spindle 52 engaged in a spindle hole 19 of the lock case 1. The mounting plate 41 may include an opening 416 through which the end 141 of the outside handle 14 extends. The spring device 5 is mounted in the opening 416 of the cover plate 42. Thus, when the outside handle 14 is turned, the spindle 52 is turned to retract the latch bolt 11, which is conventional.

The escutcheon assembly in accordance with the present invention presents a sleek, attractive appearance without obstructing removal of the interchangeable lock core 31 from the lock cylinder 3, for one can only see the figure-8-shaped front face of the lock core 31 via the figure-8-shaped through-hole 421 of the cover plate 42 from outside. The thicknesses of the mounting plate 41 and the cover plate 42 may be small without affecting the strength. Thus, the mounting plate 41 and the cover plate 42 can be formed by inexpensive punching. The manufacturing cost is cut accordingly. Further, in a case that the cover plate 42 stains or rusts, the replacement of the cover plate 42 is easy and cheap, for it is not necessary to replace the mounting plate 41 and for the cover plate 42 is inexpensive. Further, the screws 16 for fixing the mounting plate 41 is shielded by a plate 18 mounted to an inner face 25 of the door 2, improving the inner appearance.

Although specific embodiments have been illustrated and described, numerous modifications and variations are still possible without departing from the essence of the invention. The scope of the invention is limited by the accompanying claims.

What is claimed is:

1. An escutcheon assembly for a lock comprising a lock cylinder, the lock cylinder comprising a lock body and an interchangeable lock core that is removably mounted in the lock body and that has a figure-8-shaped cross section, the escutcheon assembly comprising:
a mounting plate adapted to be mounted to a front face of a door, the mounting plate comprising a receiving section for receiving the lock body; and
a cover plate securely mounted around the mounting plate, the cover plate comprising a figure-8-shaped through-hole aligned with the figure-8-shaped cross section of the interchangeable lock core.

2. The escutcheon assembly as claimed in claim 1, with the receiving section of the cover plate comprising a recessed portion extending rearward from an inner face of the mounting plate, the receiving section comprising an end wall having a through-hole through which the lock body extends.

3. The escutcheon assembly as claimed in claim 1, with the cover plate comprising a perimeter wall securely engaged with a perimeter of the mounting plate.

4. The escutcheon assembly as claimed in claim 1, with the figure-8-shaped through-hole of the cover plate having a size substantially the same as that of the figure-8-shaped cross section of the interchangeable lock core.

5. The escutcheon assembly as claimed in claim 1, with the mounting plate comprising two mounting posts each having a screw hole, with two screws extending into the screw holes of the mounting posts for fixing the mounting plate to the door.

6. The escutcheon assembly as claimed in claim 1, with the cover plate further comprising an opening adapted to be extended through by an end of an outside handle.
